(19) United States
(12) Patent Application Publication
(10) Pub. No.: US 2025/0328574 A1
(43) Pub. Date: Oct. 23, 2025

(54) DATA PROCESSING METHOD, ELECTRONIC DEVICE, STORAGE MEDIUM AND PROGRAM PRODUCT

(71) Applicants: Beijing Zitiao Network Technology Co., Ltd., Beijing (CN); Lemon Inc., Grand Cayman (KY)

(72) Inventors: Taowen YUAN, Beijing (CN); Cunyuan SOONG, Singapore (SG); Shihao REN, Singapore (SG)

(21) Appl. No.: 19/186,392

(22) Filed: Apr. 22, 2025

(30) Foreign Application Priority Data
Apr. 22, 2024 (WO) PCT/CN2024/089110

(51) Int. Cl. G06F 16/353

(52) U.S. Cl. CPC G06F 16/353

(57) ABSTRACT

The present disclosure relates to a data processing method, an electronic device, a storage medium and a program product, and relates to the field of data processing. The data processing method includes: processing each sample in a first sample set by using a first machine learning model to obtain a prediction probability that each sample is classified into each category of one or more categories; and determining, for the each category, a probability threshold corresponding to the category to maximize a number of positives of the category, wherein a confidence corresponding to the category is not lower than a confidence threshold, the probability threshold is for determining a category to which the each sample pertains based on a prediction probability of the each sample, and the confidence corresponding to the category is a confidence at which an actual precision of classification based on the probability threshold meets a precision condition.

### CROSS-REFERENCE TO RELATED APPLICATIONS

The present disclosure is based on and claims the priority of International Patent Application for No. PCT/CN2024/089110, filed on Apr. 22, 2024, the disclosure of which is hereby incorporated into this disclosure by reference in its entirety.

### TECHNICAL FIELD

The present disclosure relates to the field of data processing, in particular to a data processing method, an electronic device, a storage medium and a program product.

### BACKGROUND

In service scenarios such as content audit and data annotation, it is necessary to accurately classify and label the samples. In the related art, the samples may be labeled by a manual audit method. However, by only depending on this method, it is not only time-consuming and laborsome with a high cost, but also likely to be affected by subjective factors, which leads to inconsistent results. In order to improve the labeling efficiency and the labeling result consistency, a machine learning model may be used for an automatic labeling process.

### SUMMARY

The summary of this invention is provided to introduce concepts in a concise form, which will be described in detail in the following detailed description. The summary of this invention is neither intended to identify the key features or essential features of the technical solution for which protection is sought, nor intended to limit the scope of the technical solution for which protection is sought.

According to some embodiments of the present disclosure, a data processing method is provided. The data processing method includes: processing each sample in a first sample set by using a first machine learning model to obtain a prediction probability that each sample is classified into each category of one or more categories; and determining, for the each category, a probability threshold corresponding to the category to maximize a number of positives of the category, wherein a confidence corresponding to the category is not lower than a confidence threshold, the probability threshold is for determining a category to which the each sample pertains based on a prediction probability of the each sample, and the confidence corresponding to the category is a confidence at which an actual precision of classification based on the probability threshold meets a precision condition.

According to some embodiments of the present disclosure, an electronic device is provided. The electronic device comprises: a memory; and a processor coupled to the memory, wherein the processor is configured to perform the data processing method according to any embodiment of the present disclosure based on instructions stored in the memory.

According to some embodiments of the present disclosure, a non-transitory computer-readable storage medium is provided. The computer-readable storage medium has a computer program stored thereon that, when executed by a processor, performs the data processing method according to any of the embodiments in the present disclosure.

According to some embodiments of the present disclosure, a non-transitory computer program product is provided. The computer program product that, when run on a computer, causes the computer to implement the data processing method according to any of the embodiments in the present disclosure.

According to some embodiments of the present disclosure, a computer program is provided. The computer program includes: instructions that, when executed by a processor, cause the processor to perform the data processing method according to any of the embodiments in the present disclosure.

Other features, aspects and advantages of the present disclosure will become apparent from the following detailed description of exemplary embodiments of the present disclosure with reference to the accompanying drawings.

### BRIEF DESCRIPTION OF THE DRAWINGS

Hereinafter, preferred embodiments of the present disclosure will be described with reference to the accompanying drawings. The accompanying drawings described herein are used to provide a further understanding of the present disclosure, and each of the accompanying drawings together with the following detailed description is included in this specification and forms a part of this specification to explain the present disclosure. It should be understood that, the accompanying drawings in the following description only relate to some embodiments of the present disclosure, but do not constitute a limitation to the present disclosure. In the accompanying drawings:

FIG. 1 shows a schematic flow chart of a data processing method according to some embodiments of the present disclosure.

FIG. 2 shows a schematic flow chart of a method for determining a probability threshold according to some embodiments of the present disclosure.

FIG. 3 shows a schematic flow chart of data processing according to some embodiments of the present disclosure.

FIG. 4 shows a schematic structural view of a data processing device according to some embodiments of the present disclosure.

FIG. 5 shows a schematic structural view of an electronic device according to some embodiments of the present disclosure.

FIG. 6 shows a schematic structural view of a computer system according to some embodiments of the present disclosure.

It should be understood that, for ease of description, the sizes of various parts shown in the accompanying drawings are not necessarily drawn according to actual proportional relationships. The same or similar reference numerals are used in various accompanying drawings to denote the same or similar components. Therefore, once an item is defined in one accompanying drawing, it might not be discussed further in subsequent accompanying drawings.

### DETAILED DESCRIPTION

The technical solutions in the embodiments of the present disclosure will be explicitly and completely described below in conjunction with the accompanying drawings in the embodiments of the present disclosure. However, apparently, the embodiments described are merely some of the embodiments of the present disclosure, rather than all of the embodiments. The following description of the embodiments is actually only illustrative, and by no means serves as any limitation to the present disclosure and its application or use. It should be understood that the present disclosure may be implemented in various forms, and should not be construed as being limited to the embodiments set forth herein.

It should be understood that the various steps recited in the method embodiments of the present disclosure may be performed according to different sequences, and/or performed in parallel. In addition, the method embodiments may include additional steps and/or omit to perform the illustrated steps. The scope of the present disclosure is not limited in this respect. Unless specifically stated otherwise, the relative arrangement of components and steps, the numerical expressions, and the values set forth in these embodiments should be construed as merely exemplary, but do not limit the scope of the present disclosure.

The term “comprising” and its variations used in the present disclosure represent an open term that includes at least the following elements/features but does not exclude other elements/features, that is, “including but not limited to”. In addition, the term “including” and its variations used in the present disclosure represent an open term that includes at least the following elements/features, but does not exclude other elements/features, that is, “including but not limited to”. Therefore, comprising and including are synonymous. The term “based on” means “at least partially based on”.

The term “an embodiment”, “some embodiments” or “embodiment” throughout the specification means that a specific feature, structure, or characteristic described in combination with the embodiment(s) is included in at least one embodiment of the present invention. For example, the term “an embodiment” means “at least one embodiment”; the term “another embodiment” means “at least one additional embodiment”; and the term “some embodiments” means “at least some embodiments”. Moreover, the presences of the phrases “in one embodiment”, “in some embodiments” or “in an embodiment” in various places throughout the specification do not necessarily all refer to the same embodiment, but may also refer to the same embodiment.

It should be noted that the concepts such as “first” and “second” mentioned in the present disclosure are only used to distinguish different devices, modules or units, but not to limit the order or interdependence of functions performed by these devices, modules or units. Unless otherwise specified, the concepts such as “first” and “second” are not intended to imply that the objects thus described have to follow a given order in terms of time, space and ranking, or a given order in any other manner.

It should be noted that the modifications of “one” and “a plurality of” mentioned in the present disclosure are illustrative rather than restrictive, and those skilled in the art should understand that they should be understood as “one or more” unless contextually specified otherwise.

The names of messages or information exchanged between multiple devices in the embodiments of the present disclosure are only used for illustrative purposes, but not for limiting the scope of these messages or information.

The embodiments of the present disclosure will be described in detail below in conjunction with the accompanying drawings, but the present disclosure is not limited to these specific embodiments. The following specific embodiments may be combined with each other, and the same or similar concepts or processes will not be described in detail in some embodiments. In addition, in one or more embodiments, specific features, structures, or characteristics may be combined by those of ordinary skill in the art in any suitable manner that will be apparent from the present disclosure.

It has been found through studies that, there are also some problems during the process of using a machine learning model for automatic labeling. The prediction of the model might produce errors due to a plurality of factors such as the deviation of the training data and the generalization ability of the model. In addition, when a sample is labeled (i.e., classified), it is necessary to combine a prediction probability and a probability threshold of each classification output by the model so as to determine a category to which the sample pertains. However, if the same threshold is used all the time, it is possible not to adapt to a dynamic data distribution and affect the prediction precision. If potential false positives are excluded by simply raising the probability threshold, it is possible to reduce a recall rate.

In order to improve the precision of model prediction, the present disclosure provides a method capable of dynamically adjusting a threshold to adapt to the changes of data and meet the requirements of precision and confidence, thereby improving the reliability of automatic labeling. In some embodiments of the present disclosure, after training is completed by the machine learning model for sample classification, a probability threshold of the machine learning model is determined by using the sample set so as to maintain or promote a recall rate as much as possible to meet the service requirements in the case where the requirements of precision and confidence are met.

First of all, some technical terms used in the present disclosure will be defined below.

The test sample set is a set of samples for testing the machine learning model. During the process of training and testing the machine learning model, the samples with labeled categories may be obtained in advance and divided into a training set and a testing set. For example, for a multi-classification problem, the category label is nᵢ∈N(∥N∥=C), where N represents a set of one or more categories and C represents the number of categories. The labeled samples are divided into a training set T(∥T∥=N_{T}) and a test set S(∥S|=N_{S}), where N_{T} represents the number of samples in the training set and N_{S} represents the number of samples in the test set. Based on the training set T, the machine learning model may be obtained by training. The training set T(∥T∥=N_{T}) and the test set S(∥S|=N_{S}) may be combined into a large data set D_{ALL}=T∪S, wherein N_{ALL}=N_{T}+N_{S} samples are contained. The probability distribution of the category nᵢ in the union set D_{ALL} of the training set and the test set may be expressed by \tilde{p}₁. Then, for each category nᵢ, \tilde{p}ᵢ=yᵢ^{train}+yᵢ^{test}/N_{ALL}, where yᵢ^{train} and yᵢ^{test} represent the number of samples of the category nᵢ in the training set and the test set respectively. When the sample size is large enough, \tilde{p}ᵢ may serve as an approximation of a true distribution of the category nᵢ.

The machine learning model is configured to process an input sample and determine an output result. In some embodiments of the present disclosure, the machine learning model is configured to classify the samples. For example, the probability that a sample pertains to each category is determined. The machine learning model may be a neural network model. Other types of models may also apply as required, which will not be described in detail here.

The probability threshold is used to classify the samples based on a prediction probability of the machine learning model. In some embodiments of the present disclosure, a probability threshold may be set for each of one or more categories respectively. In the case where the probability that a certain sample pertains to a certain category is higher than a probability threshold corresponding to the category, it is determined that the sample pertains to the category. For example, in some machine learning models, a softmax layer may be set. Alternatively, a softmax layer may be connected in series after the machine learning model. After a layer preceding softmax in the machine learning model or the machine learning model itself processes the samples, the softmax layer processes a vector input therein to obtain the probability that the sample pertains to each category. According to the probability threshold (or referred to as a softmax threshold), the predicted category to which the sample pertains may be further determined.

The positive under a certain category refers to a sample divided into this category based on a prediction result and a probability threshold of the machine learning model. The positive includes True Positive and False Positive. The true positive refers to a positive in which a pre-labeled result is consistent with a divided result. For example, it is determined that a certain sample pertains to a category 1 based on the machine learning model and the probability threshold, and the label of the sample also represents that it pertains to a category 1. The false positive is a positive in which a labeled result is inconsistent with a divided result. For example, it is determined that a certain sample pertains to a category 1 based on the machine learning model and the probability threshold, but the label of the sample represents that it does not pertain to a category 1.

The prediction precision (also referred to as precision degree) of a certain category refers to a ratio of the number of true positives of this category to the number of all the positives of this category. For example, in the prediction result, if there are 100 samples pertaining to a certain category A, the number of positives of this category A will be 100. Among these 100 samples, 80 samples are pre-labeled as this category A (that is, actually pertaining to this category A) and 20 samples are pre-labeled as one or more categories other than the category A (that is, actually not pertaining to a category A). Then, for a category A, the prediction precision is 0.8.

The confidence refers to a measure of the reliability of an inference result. For example, during the prediction, there are certain requirements for the prediction precision of a certain category, but the requirements for the precision should have a certain confidence at the same time.

The embodiment of the sample processing method of the present disclosure will be described below with reference to FIG. 1.

FIG. 1 shows a schematic flow chart of a data processing method according to some embodiments of the present disclosure. As shown in FIG. 1, the sample processing method of this embodiment includes steps S102 to S104.

In step S102, each sample in a first sample set is processed by using a first machine learning model to obtain a prediction probability that each sample is classified into each category of one or more categories.

The first machine learning model is configured to process an input sample of the first sample set and determine an output result. In some embodiments of the present disclosure, the machine learning model is configured to classify the samples. The first machine learning model may process the input sample to obtain a vector corresponding to the sample, and obtain a probability that the sample pertains to each category through an activation layer such as softmax. The first machine learning model may be a neural network model. Other types of models may also apply as required, which will not be described in detail here.

The first machine learning model is configured to classify or label the samples, which may be a Binary Classification model, a Multi-Class Classification model, a Multi-Label Classification model and a Hierarchical Classification model, wherein multi-label classification and hierarchical classification may also be regarded as one of multi-class classifications.

In some embodiments, the machine learning model includes a softmax layer, the prediction probability that the each sample is divided into each of one or more categories is output by the softmax layer, and the probability threshold is a softmax threshold.

The first sample set is a set including a plurality of samples. The first sample set may be, for example, a test set. Therefore, after training for the first machine learning model is completed, the first machine learning model may be tested by using the test set, and the probability threshold may be determined by using the test set.

In step S104, for the each category, a probability threshold is determined corresponding to the category to maximize a number of positives of the category, wherein a confidence corresponding to the category is not lower than a confidence threshold.

The probability threshold is used to determine a category to which each sample pertains based on a prediction probability of each sample. For example, for the each category, in response to that a prediction probability of the sample is not lower than a probability threshold of the category, it is determined that the sample pertains to the category; and in response to that the prediction probability of the sample is lower than the probability threshold of the category, it is determined that the sample does not pertain to the category. For each category, the number of positives of this category refers to the number of samples divided into this category.

The confidence corresponding to the category is a confidence at which an actual precision (or referred to as Ground Truth precision) of classification based on the probability threshold meets a precision condition. The precision condition is, for example, that the actual precision is greater than a certain degree, that is, the probability threshold can allow that the prediction precision is greater than a certain degree, and the requirement of the precision has a certain confidence.

The actual precision is an overall precision determined based on the first machine learning model and the probability threshold, which may be measured in the case where the number of samples is enough, but it is difficult to obtain the actual precision. A relative one is an observation precision (or the empirical precision or evaluation precision), which is based on an observation result of the first sample set. The observation precision is easily obtained, but there might be a certain gap from the actual precision. However, the actual precision may affect the number of observed positives and the observation precision. Therefore, if the actual precision can be determined, it is possible to determine the number of corresponding positives and the observation precision.

The formula (1) exemplarily shows an objective function, and the formula (2) exemplarily shows a constraint condition of the objective function. Those skilled in the art may process these formulas by appropriate deformations as required, which will not be described in detail in the present disclosure.

$${softmax\_threshold}^{*} = {arg max}_{softmax\_threshold} {n}_{p o s} \qquad ( 1 )$$

$$confidence ( {pr}_{actual} \geq x ) \geq {confidence}_{threshold} \qquad ( 2 )$$

In the above-described formula, softmax_threshold represents a softmax threshold, which may also be other types of probability thresholds as required; nₚₒₛ represents the number of positives determined based on the softmax_threshold; pr_{actual} represents an actual precision, or is referred to as the Ground Truth precision; confidence (pr_{actual}≥x) represents a confidence at which an actual precision is greater than x, and x is a value to be determined; and confidence_{threshold} represents a confidence threshold, which is a known value.

Since the number of positives of the each category in a prediction result may be affected by determining a probability threshold, that is, there is an associated relationship between the probability threshold and the number of positives, it is possible to take the maximization of the number of positives of the category as a solution objective, and take a confidence that is not lower than a confidence threshold as a constraint condition. Since the confidence threshold is known, it is possible to obtain a precision condition that can meet a confidence requirement, so that the number of positives and the observation precision may be determined according to the precision condition so as to further determine a probability threshold.

After a probability threshold is determined, a sample to be processed may be classified based on the first machine learning model and a probability threshold corresponding to each category.

During the process of labeling the sample to be processed, the sample to be processed is processed by using a first machine learning model to obtain the probability that the sample to be processed pertains to the each category, and the category to which the sample to be processed pertains is determined based on the probability threshold determined in step S104, so as to perform classification. Therefore, it is possible to obtain a processing result of the sample to be processed in the case where the requirements of confidence and recall are met.

In the above-described embodiments, it is possible to finely and automatically determine a probability threshold of each category based on a data distribution condition in the first sample set. Therefore, in the embodiment of the present disclosure, it is possible to scientifically maintain the confidence within a service acceptable range so as to greatly improve the robustness, and it is possible to improve a recall as much as possible to meet the service requirements in the case where the confidence requirements are met.

In some embodiments, the confidence corresponding to the category is determined according to a target probability, wherein the target probability is: the probability of obtaining the number of positives and the observation precision determined based on the first sample set under the condition that the probability threshold possesses the actual precision.

The target probability takes the actual precision as a prior condition. For example, for any category, the target probability may be represented by P(nₚₒₛ, prₑᵥₐₗ|pr_{actual}), where nₚₒₛ represents the number of positives of this category in a prediction result of the first sample set, prₑᵥₐₗ represents the observation precision of this category in a prediction result of the first sample set, and pr_{actual} represents an actual precision. The target probability may be determined by the formula (3), for example.

$$P ( {n}_{p o s} , p {r}_{eval} \vert {pr}_{actual} ) = \frac{{n}_{p o s} ! \cdot {( {pr}_{actual} {}^{p {r}_{eval}} \cdot {( 1 - p {r}_{actual} )}^{1 - {pr}_{eval}} )}^{{n}_{p o s}}}{( p {r}_{eval} \cdot {n}_{p o s} ) ! \cdot ( ( 1 - p {r}_{eval} ) \cdot {n}_{p o s} ) !} \qquad ( 3 )$$

In the formula (3), the number of true positives in the positives may be determined based on the number of positives predicted by using the first sample set and the observation precision. That is, when the number nₚₒₛ of positives and the observation precision prₑᵥₐₗ are determined, the number of true positives in the positives may be calculated by a product of them. Furthermore, the target probability may be determined by considering the possibility of all the combinations of true positives in the positives, and determining an actual probability of each true positive and an actual probability of each false positive based on an actual precision.

When the formula (3) is processed, the calculation amount of factorial operation is also very large in the case where a huge number of samples leading to a very large number of positives. In order to improve the calculation efficiency, factorial operation may be simplified by using Stirling's approximation. Of course, those skilled in the art may also use other methods for calculation, and the present disclosure is not limited thereto.

In some embodiments, the confidence corresponding to the category is determined according to a first sum and a second sum, where the first sum is a sum of values of the target probability that meet the precision condition, and the second sum is a sum of all the values of the target probability. The first sum and the second sum may be determined by integrating the actual precision, that is, the first sum is to integrate the target probability in the interval meeting the precision condition, and the second sum is to integrate the target probability in the whole interval of [0,1]. That is, the confidence may be determined by the area under the function curve of the target probability. For example, the abscissa is the actual precision and the ordinate is the target probability, and the value x of the abscissa is determined so that the ratio of the area under the curve corresponding to the abscissa greater than this value to the total area under the curve is equal to the confidence threshold, so as to solve the precision condition: the actual precision is greater than x. Therefore, the confidence that the actual precision is greater than x may be greater than the confidence threshold.

In some embodiments, the probability density function of the target probability follows a conjugate prior distribution. The conjugate prior distribution may, for example, use a Beta distribution. One exemplary formula of the confidence is shown in the formula (4), where α and β are parameters in the beta distribution. In an initial state, α and β may be set as initial values.

$$confidence ( {pr}_{actual} \geq x ) = \frac{{\int }_{X}^{1} P ( {n}_{pos} , {pr}_{eval} \vert {pr}_{actual} ) \cdot Beta ( {pr}_{actual} \vert α , β ) {dpr}_{actual}}{{\int }_{0}^{1} P ( {n}_{pos} , {pr}_{eval} \vert {pr}_{actual} ) \cdot Beta ( {pr}_{actual} \vert α , β ) {dpr}_{actual}} \qquad ( 4 )$$

Since the process of the model might be continuous, on such basis, for each category, it is possible to obtain a plurality of probability thresholds determined for multiple times and corresponding to the category, and determine a plurality of observation precisions determined for a plurality of probability thresholds. For example, when K-fold cross-validation is passed, the parameters may be updated by the observation precisions evaluated for multiple times. Then, the parameters of the distribution of the probability density function of the actual precision are determined by using the plurality of observation precisions. Therefore, the updated parameters may allow the distribution to conform more to actual conditions of the actual precision, so that it is possible to improve the precision and reliability of determining a threshold by multiple iteration processes.

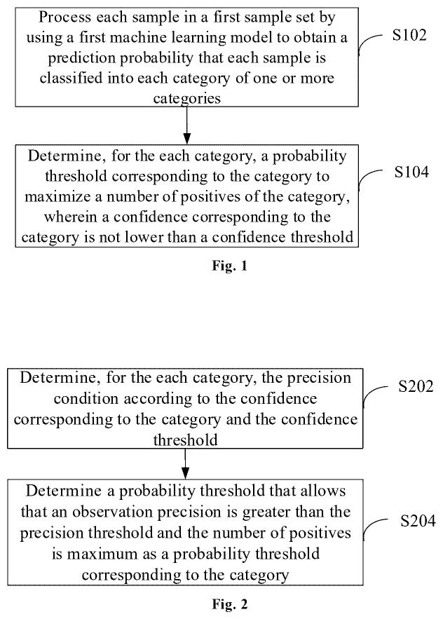

The embodiment of the method for determining a probability threshold will be described below with reference to FIG. 2.

FIG. 2 shows a schematic flow chart of a method for determining a probability threshold according to some embodiments of the present disclosure. As shown in FIG. 2, the method for determining a probability threshold of this embodiment includes steps S202 to S204. These steps may be applied to any category.

In step S202, for the each category, the precision condition is determined according to the confidence corresponding to the category and the confidence threshold. In conjunction with the explanations in the aforementioned embodiments, there is a certain associated relationship between the confidence and the actual precision. In the case where the confidence threshold is known, a precision condition may be solved. For example, the relationship between the confidence and the actual precision is monotonic, so that dichotomy may be used to determine the actual precision corresponding to a specified confidence threshold, that is, the precision threshold x in the precision condition.

In step S204, a probability threshold that allows that an observation precision is greater than the precision threshold and the number of positives is maximum is determined as a probability threshold corresponding to the category. For example, the optimal solution may be determined by traversing the values of the probability threshold. Of course, other methods may also be used, which will not be described in detail here.

A method of determining a probability threshold corresponding to the each category based on the first sample set is introduced in the above-described embodiments. In the above-described embodiments, it is possible to process a large amount of data in real time by dynamically determining a threshold through an inference algorithm without leading to a low efficiency due to the consumption of computing resources, thereby improving the performance of an automated process.

The method of the above-described embodiments may be performed for multiple times as required to continuously update the probability threshold according to a change condition of data. For example, in response to updating the first sample set, the probability threshold corresponding to each category is re-determined. Therefore, the embodiment of the present disclosure may adapt to the change of data distribution, so as to apply the first machine learning model to different application scenarios or at different times, and obtain a favorable prediction effect.

The embodiment of the present disclosure may be applied to an automatic labeling scenario of data, a data auditing scenario and the like. These two scenarios will be exemplarily introduced below.

In an automatic labeling scenario of data, first of all, the method of the above-described embodiments is used to determine a probability threshold corresponding to each category based on the first sample set. Then, a classification result of a sample in a second sample set to be processed is determined based on the first machine learning model and a probability threshold corresponding to the each category, wherein the second sample set is the training data of the second machine learning model; and the sample in the second sample set is labeled according to the classification result. Therefore, the labeling result of the labeled sample in the second sample set may have a high confidence, so that the second machine learning model may possess a better training result.

In a data auditing scenario, first of all, the method of the above-described embodiments is used to determine a probability threshold corresponding to each category based on the first sample set. Then, a sample to be processed is classified based on the first machine learning model and a probability threshold corresponding to each category, wherein the classification result includes audit passed and audit failed. In the case where audit fails, it is possible to output the sample to the manually audited data stream for manual audit.

The sample to be audited is, for example, an online sample. In response to that the labeling result of the online sample indicates that audit is passed, the online sample is output online. In response to that the labeling result of the online sample indicates that audit fails, a sample pool is updated by using the online sample, where the sample pool is used to train or test the first machine learning model. Therefore, the labeled sample is used to update the first sample set, and the updated first sample set is used to retrain the first machine learning model, or test the first machine learning model, or re-determine the probability threshold.

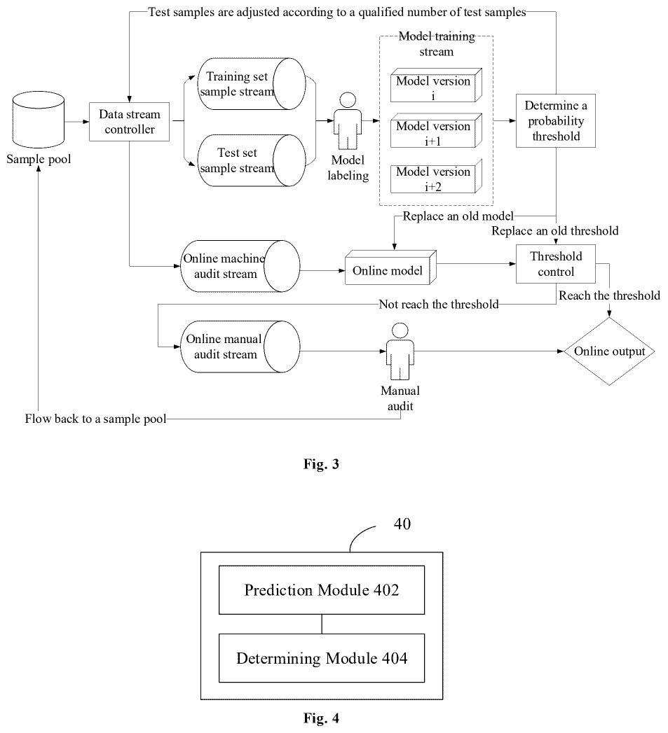

FIG. 3 shows a schematic flow chart of data processing according to some embodiments of the present disclosure. In FIG. 3, the data flow controller selects samples from the sample pool as required and sends the samples to the training set sample stream and the test set sample stream respectively. The training set sampling stream is used to train the machine learning model, and the test set sampling stream is used to test the model for which training has been completed. Since these samples are not labeled, it is necessary to manually label the data so that the labeled samples are used for model training and testing. In the model training flow, the model may be trained for multiple times, and the model versions that have been trained for multiple times are labeled as i, i+1, i+2 or the like. After the training process of each version of model is completed, the probability threshold may be determined by using the method of the embodiment of the present disclosure.

The updated model may replace the old model available online, and the new probability threshold determined based on the updated model may also replace the original threshold. Then, the online machine audit flow may be provided by the data flow controller. The online model processes a sample in the online machine audit flow to obtain a prediction probability, and then performs threshold control by combining the new probability threshold to determine whether the sample passes audit. If audit is passed, online output will be performed. If audit fails, online manual audit will be performed, and after manual audit is passed, online output will be performed and at the same time, the sample will flow back to the sample pool.

In the above-described embodiments, it is possible to integrate a real-time feedback into the training sample control flow by using a data-centric model iteration mechanism, which realizes labeling on-demand and effectively reduces the labeling cost. Moreover, by introducing statistical deduction, it is possible to perform refined and automatic control on different target labels according to the distribution of the test samples and other relevant inputs. This not only ensures the stability of the precision, but also may scientifically maintain the confidence interval within an acceptable range of the service, which significantly improves the robustness.

The related embodiments of the data processing method of the present disclosure have been described above. The related apparatuses and devices in some embodiments of the present disclosure will be introduced below.

FIG. 4 shows a schematic structural view of a data processing device according to some embodiments of the present disclosure. As shown in FIG. 4, the data processing device 40 of this embodiment includes: a prediction module 402 configured for processing each sample in a first sample set by using a first machine learning model to obtain a prediction probability that each sample is classified into each category of one or more categories; and a determining module 404 configured for determining, for the each category, a probability threshold corresponding to the category to maximize a number of positives of the category, wherein a confidence corresponding to the category is not lower than a confidence threshold, the probability threshold is for determining a category to which the each sample pertains based on a prediction probability of the each sample, and the confidence corresponding to the category is a confidence at which an actual precision of classification based on the probability threshold meets a precision condition.

In some embodiments, the confidence corresponding to the category is determined according to a target probability, wherein the target probability is: a probability of obtaining a number of positives and an observation precision determined based on the first sample set in response to the probability threshold possessing the actual precision.

In some embodiments, the confidence corresponding to the category is determined according to a first sum and a second sum, wherein the first sum is a sum of values of the target probability that meet the precision condition, and the second sum is a sum of all the values of the target probability.

In some embodiments, a probability density function of the target probability follows a conjugate prior distribution.

In some embodiments, the determining module 404 is further configured for: determining, for the each category, the precision condition according to the confidence corresponding to the category and the confidence threshold; and determining a probability threshold that allows that an observation precision is greater than the precision threshold and the number of positives is maximum as a probability threshold corresponding to the category.

In some embodiments, the precision condition is that the actual precision is greater than a specified value.

In some embodiments, the data processing device 40 further includes an updating module configured for re-determining the probability threshold corresponding to the each category in response to updating the first sample set.

In some embodiments, the data processing device 40 further includes a parameter determining module configured for: obtaining, for the each category, a plurality of probability thresholds determined for multiple times and corresponding to the category; determining a plurality of observation precisions determined for the plurality of probability thresholds; and determining parameters of a distribution of a probability density function of the actual precision by using the plurality of observation precisions.

In some embodiments, the machine learning model comprises a Softmax layer, the prediction probability is output by the Softmax layer, and the probability threshold is a Softmax threshold.

In some embodiments, the data processing device 40 further includes a classification module configured for classifying a sample to be processed based on the first machine learning model and the probability threshold corresponding to the each category.

In some embodiments, the classification module is further configured for: determining a classification result of a sample in a second sample set to be processed based on the first machine learning model and the probability threshold corresponding to the each category, wherein the second sample set is training data of the second machine learning model; and labeling the sample in the second sample set according to the classification result.

In some embodiments, the sample to be processed is an online sample to be audited, and the data processing device 40 further includes an auditing module configured for outputting the online sample online in response to that a labeling result of the online sample indicates that audit is passed.

In some embodiments, the auditing module is further configured for: updating a sample pool by using the online sample in response to that the labeling result of the online sample indicates that the audit is failed, wherein the sample pool is for training or testing the first machine learning model.

It should be noted that, the above-described units are only logical modules divided according to the specific functions realized by the same, but not intended to limit specific implementations. For example, it is possible to be implemented in the form of software, hardware, or a combination of software and hardware. In actual implementation, each of the above-described units may be implemented as an independent physical entity, or may also be implemented by a single entity (for example, a processor (CPU or DSP, and the like), an integrated circuit, etc.). In addition, the above-described respective units are shown with dotted lines in the accompanying drawings to indicate that these units may not actually exist, and the operations/functions realized by them may be implemented by the processing circuit itself.

In addition, although not shown, the device may also include a memory, which may store various information generated by the device and various units included in the device during operation, programs and data for operation, data to be sent by the communication unit, and the like. The memory may be a volatile memory and/or a non-volatile memory. For example, the memory may include, but is not limited to, a random access memory (RAM), a dynamic random access memory (DRAM), a static random access memory (SRAM), a read only memory (ROM), and a flash memory. Of course, the memory may also be located outside the device. Alternatively, although not shown, the device may also include a communication unit, which may be used to communicate with other devices. In one example, the communication unit may be implemented in an appropriate manner known in the art, for example, including communication components such as antenna arrays and/or radio frequency links, various types of interfaces, communication units, and the like, which will not be described in detail here. Detailed description will not be repeated here. In addition, the device may also include other components not shown, such as a radio frequency link, a baseband processing unit, a network interface, a processor, a controller, and the like, which will not be described in detail here. Detailed description will not be repeated here.

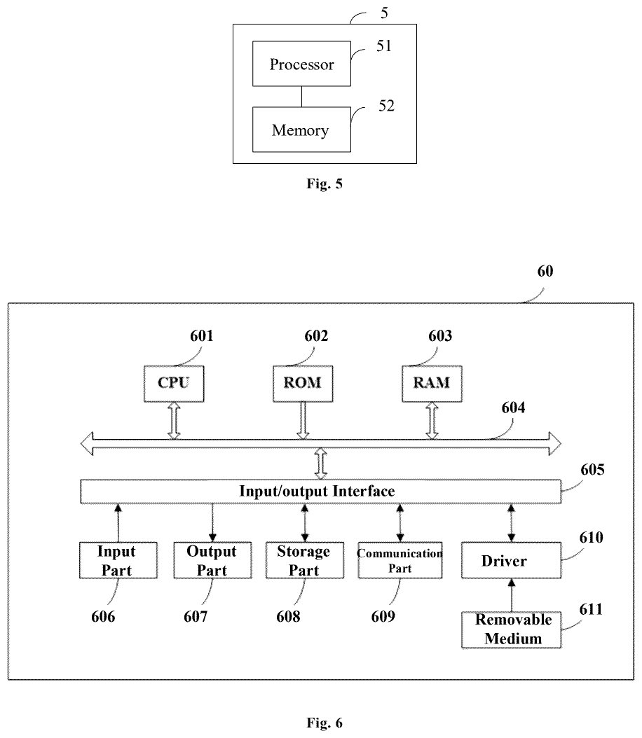

In some embodiments of the present disclosure, an electronic device is also provided. FIG. 5 shows a schematic structural view of an electronic device according to some embodiments of the present disclosure. For example, in some embodiments, the electronic device 5 which may be various types of devices, for example may include, but is not limited to mobile terminals such as mobile phones, notebook computers, digital broadcast receivers, PDAs (personal digital assistants), PADs (pad computers), PMP (Portable Multimedia Player) and in-vehicle terminals (for example, in-vehicle navigation terminals); and fixed terminals such as digital TVs, desktop computers and the like. For example, the electronic device 5 may include a display panel for displaying data and/or execution results used in the solution according to the present disclosure. For example, the display panel may have various shapes, such as a rectangular panel, an oval panel, or a polygonal panel. In addition, the display panel may be not only a flat panel, but also a curved panel, or even a spherical panel.

As shown in FIG. 5, the electronic device 5 of this embodiment includes: a memory 51, and a processor 52 coupled to the memory 51. It should be noted that the components of the electronic device 5 shown in FIG. 5 are only exemplary, but not restrictive. According to actual application requirements, the electronic device 5 may also have other components. The processor 52 may control other components in the electronic device 5 to perform desired functions.

In some embodiments, the memory 51 is configured to store one or more computer-readable instructions. When the processor 52 is configured to run computer-readable instructions, the computer-readable instructions are executed by the processor 52 to implement the method according to any of the above-described embodiments. For the specific implementation of each step of the method and the related content as explained, it is possible to refer to the above-described embodiments, which will not be described in detail here.

For example, the processor 52 and the memory 51 may directly or indirectly communicate with each other. For example, the processor 52 and the memory 51 may communicate through a network. The network may include a wireless network, a wired network, and/or any combination of a wireless network and a wired network. The processor 52 and the memory 51 may also communicate with each other through a system bus, which is not limited in the present disclosure.

For example, the processor 52 may be embodied as various appropriate processors, processing devices and the like, such as a central processing unit (CPU), a graphics processing unit (GPU) and a network processor (NP); and may also be a digital signal processor (DSP), an application specific integrated circuit (ASIC), a field programmable gate array (FPGA) or other programmable logic devices, a discrete gate or transistor logic device, and a discrete hardware component. The central processing unit (CPU) may be X86 or ARM architecture and the like. For example, the memory 51 may include any combination of various forms of computer-readable storage media, such as a volatile memory and/or a non-volatile memory. The memory 51 may include, for example, a system memory. The memory 51 may include, for example, a system memory. The system memory, for example, stores an operating system, an application program, a boot loader, a database, and other programs. Various application programs and various data may also be stored in the storage medium.

In addition, according to some embodiments of the present disclosure, in the case where various operations/processes according to the present disclosure are implemented by software and/or firmware, it is possible to install a program constituting the software to a computer system with a dedicated hardware structure, for example, the computer system 60 shown in FIG. 6, from a storage medium or a network. When the computer system is installed with various programs, it is possible to perform various functions, including the functions described previously. FIG. 6 shows a schematic structural view of a computer system according to some embodiments of the present disclosure.

In FIG. 6, a central processing unit (CPU) 601 executes various processes according to a program stored in a read only memory (ROM) 602 or a program loaded from a storage portion 608 to a random access memory (RAM) 603. In the RAM 603, data required when the CPU 601 executes various processes and the like is also stored as necessary. The central processing unit which is only exemplary, may also be other types of processors, such as the processors described above. The ROM 602, the RAM 603, and the storage portion 608 may be various forms of computer-readable storage media, as described below. It should be noted that although the ROM 602, the RAM 603, and the storage device 608 are shown in FIG. 6 respectively, one or more of them may be combined or located in the same or different memories or storage modules.

The CPU 601, the ROM 602, and the RAM 603 are connected to each other via a bus 604. The input/output interface 605 is also connected to the bus 604.

The following components are connected to the input/output interface 605: an input portion 606, such as a touch screen, a touch panel, a keyboard, a mouse, an image sensor, a microphone, an accelerometer and gyroscope; an output portion 607, including a display, such as a cathode ray tube (CRT), a liquid crystal display (LCD), a speaker, and a vibrator; a storage portion 608, including a hard disk, and a tape; and a communication portion 609, including a network interface card such as a LAN card and a modem. The communication portion 609 allows execution of communication processing via a network such as Internet. It is easily conceivable that, although the devices or modules in the computer system 60 shown in FIG. 6 communicate through the bus 604, they may also communicate through a network or other means, wherein the network may include a wireless network, a wired network, and/or any combination of a wireless network and a wired network.

The driver 610 is also connected to the input/output interface 605 as required. A removable medium 611 such as a magnetic disk, an optical disk, a magneto-optical disk and a semiconductor memory is mounted on the drive 610 as necessary, so that the computer program read out therefrom is installed into the storage portion 608 as necessary.

In a case of implementing the above-described series of processes by software, the program constituting a software may be installed from a network such as Internet or a storage medium such as a removable medium 611.

According to the embodiment of the present disclosure, the process described above with reference to the flowchart may be implemented as a computer software program. For example, the embodiment of the present disclosure includes a computer program product including a computer program carried on a computer-readable medium, wherein the computer program contains program codes for performing the method shown in the flowchart. In such embodiment, the computer program may be downloaded and installed from the network through the communication device 609, installed from the storage device 608, or installed from the ROM 602. When the computer program is executed by the CPU 601, the above-described functions defined in the method of the embodiment of the present disclosure are executed.

It should be noted that in the context of the present disclosure, a computer-readable medium may be a tangible medium, which may contain or store a program for use by the instruction execution system, apparatus, or device or use in combination with the instruction execution system, apparatus, or device. The computer-readable medium may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, apparatus, or device or used in combination therewith. In the present disclosure, the computer-readable signal medium may include a data signal propagated in a baseband or as a part of a carrier wave, wherein a computer-readable program code is carried. Such propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by an instruction execution system, apparatus, or device or in combination with therewith. The program code contained on the computer-readable medium may be transmitted by any suitable medium, including but not limited to: a wire, an optical cable, radio frequency (RF), and the like, or any suitable combination thereof.

The above-described computer-readable medium may be included in the above-described electronic device; or may also exist alone without being assembled into the electronic device.

In some embodiments, a computer program is also provided. The computer program comprises instructions, which, when executed by a processor, cause the processor to execute the method of any of the above-described embodiments. For example, the instructions may be embodied as a computer program code.

In an embodiment of the present disclosure, the computer program code for performing the operations of the present disclosure may be written in one or more programming languages or a combination thereof. The above-described programming languages include but are not limited to object-oriented programming languages, such as Java, Smalltalk, and C++, and also include conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In a case of a remote computer, the remote computer may be connected to the user's computer through any kind of network (including a local area network (LAN) or a wide area network (WAN)), or may be connected to an external computer (for example, connected through Internet using an Internet service provider).

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, wherein the module, the program segment, or the part of code contains one or more executable instructions for realizing a specified logic function. It should also be noted that, in some alternative implementations, the functions labeled in the block may also occur in a different order from the order labeled in the accompanying drawings. For example, two blocks shown in succession which may actually be executed substantially in parallel, may sometimes also be executed in a reverse order, depending on the functions involved. It is also to be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The modules, components, or units involved in the described embodiments of the present disclosure may be implemented in software or hardware. Wherein, the names of the modules, components or units do not constitute a limitation on the modules, components or units themselves under certain circumstances.

The functions described hereinabove may be performed at least in part by one or more hardware logic components. For example, without limitation, the exemplary hardware logic components that may be used include: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

The above description is only an explanation of some embodiments of the present disclosure and the applied technical principles. Those skilled in the art should understand that the scope of disclosure involved in this disclosure is not limited to the technical solutions formed by the specific combination of the above technical features, and at the same time should also cover other technical solutions formed by arbitrarily combining the above-described technical features or equivalent features without departing from the above disclosed concept. For example, the above-described features and the technical features disclosed in the present disclosure (but not limited thereto) having similar functions are replaced with each other to form a technical solution.

In the description provided herein, many specific details are elaborated. However, it is understood that the embodiments of the present invention may be implemented without these specific details. In other cases, in order not to obscure the understanding of the description, the well-known methods, structures and technologies are not demonstrated in detail.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although some specific embodiments of the present disclosure have been described in detail by way of examples, those skilled in the art should understand that the above examples are only for an illustrative purpose, rather than limiting the scope of the present disclosure. Those skilled in the art should appreciate that modifications to the above embodiments may be made without departing from the scope and spirit of the present disclosure. The scope of the present disclosure is defined by the appended claims.

I/We claim:

1. A data processing method, comprising:
processing each sample in a first sample set by using a first machine learning model to obtain a prediction probability that each sample is classified into each category of one or more categories; and
determining, for the each category, a probability threshold corresponding to the category to maximize a number of positives of the category, wherein a confidence corresponding to the category is not lower than a confidence threshold, the probability threshold is for determining a category to which the each sample pertains based on a prediction probability of the each sample, and the confidence corresponding to the category is a confidence at which an actual precision of classification based on the probability threshold meets a precision condition.

2. The data processing method according to claim 1, wherein the confidence corresponding to the category is determined according to a target probability, wherein the target probability is: a probability of obtaining a number of positives and an observation precision determined based on the first sample set in response to the probability threshold possessing the actual precision.

3. The data processing method according to claim 2, wherein the confidence corresponding to the category is determined according to a first sum and a second sum, wherein the first sum is a sum of values of the target probability that meet the precision condition, and the second sum is a sum of all the values of the target probability.

4. The data processing method according to claim 2, wherein a probability density function of the target probability follows a conjugate prior distribution.

5. The data processing method according to claim 1, wherein the determining, for the each category, a probability threshold corresponding to the category to maximize a number of positives of the category, wherein the confidence corresponding to the category is not lower than a confidence threshold, comprises:
determining, for the each category, the precision condition according to the confidence corresponding to the category and the confidence threshold; and
determining a probability threshold that allows that an observation precision is greater than the precision threshold and the number of positives is maximum as a probability threshold corresponding to the category.

6. The data processing method according to claim 1, wherein the precision condition is that the actual precision is greater than a specified value.

7. The data processing method according to claim 1, further comprising:
re-determining the probability threshold corresponding to the each category in response to updating the first sample set.

8. The data processing method according to claim 7, further comprising:
obtaining, for the each category, a plurality of probability thresholds determined for multiple times and corresponding to the category;
determining a plurality of observation precisions determined for the plurality of probability thresholds; and
determining parameters of a distribution of a probability density function of the actual precision by using the plurality of observation precisions.

9. The data processing method according to claim 1, wherein the machine learning model comprises a Softmax layer, the prediction probability is output by the Softmax layer, and the probability threshold is a Softmax threshold.

10. The data processing method according to claim 1, further comprising:
classifying a sample to be processed based on the first machine learning model and the probability threshold corresponding to the each category.

11. The data processing method according to claim 10, wherein the classifying the sample to be processed based on the first machine learning model and the probability threshold corresponding to the each category comprises:
determining a classification result of a sample in a second sample set to be processed based on the first machine learning model and the probability threshold corresponding to the each category, wherein the second sample set is training data of the second machine learning model; and
labeling the sample in the second sample set according to the classification result.

12. The data processing method according to claim 10, wherein the sample to be processed is an online sample to be audited, and the data processing method further comprises:
outputting the online sample online in response to that a labeling result of the online sample indicates that audit is passed.

13. The data processing method according to claim 12, further comprising:
updating a sample pool by using the online sample in response to that the labeling result of the online sample indicates that the audit is failed, wherein the sample pool is for training or testing the first machine learning model.

14. A non-transitory computer readable storage medium, having a computer program stored thereon that, when executed by a processor, implements a data processing method comprising:
processing each sample in a first sample set by using a first machine learning model to obtain a prediction probability that each sample is classified into each category of one or more categories; and
determining, for the each category, a probability threshold corresponding to the category to maximize a number of positives of the category, wherein a confidence corresponding to the category is not lower than a confidence threshold, the probability threshold is for determining a category to which the each sample pertains based on a prediction probability of the each sample, and the confidence corresponding to the category is a confidence at which an actual precision of classification based on the probability threshold meets a precision condition.

15. The non-transitory computer readable storage medium according to claim 14, wherein the confidence corresponding to the category is determined according to a target probability, wherein the target probability is: a probability of obtaining a number of positives and an observation precision determined based on the first sample set in response to the probability threshold possessing the actual precision.

16. The non-transitory computer readable storage medium according to claim 15, wherein the confidence corresponding to the category is determined according to a first sum and a second sum, wherein the first sum is a sum of values of the target probability that meet the precision condition, and the second sum is a sum of all the values of the target probability.

17. The non-transitory computer readable storage medium according to claim 15, wherein a probability density function of the target probability follows a conjugate prior distribution.

18. The non-transitory computer readable storage medium according to claim 14, wherein the determining, for the each category, a probability threshold corresponding to the category to maximize a number of positives of the category, wherein the confidence corresponding to the category is not lower than a confidence threshold, comprises:
determining, for the each category, the precision condition according to the confidence corresponding to the category and the confidence threshold; and
determining a probability threshold that allows that an observation precision is greater than the precision threshold and the number of positives is maximum as a probability threshold corresponding to the category.

19. The non-transitory computer readable storage medium according to claim 14, wherein the precision condition is that the actual precision is greater than a specified value.

20. An electronic device, comprising:
a memory; and
a processor coupled to the memory, the processor configured to, based on instructions stored in the memory, carry out a data processing method comprising:
processing each sample in a first sample set by using a first machine learning model to obtain a prediction probability that each sample is classified into each category of one or more categories; and
determining, for the each category, a probability threshold corresponding to the category to maximize a number of positives of the category, wherein a confidence corresponding to the category is not lower than a confidence threshold, the probability threshold is for determining a category to which the each sample pertains based on a prediction probability of the each sample, and the confidence corresponding to the category is a confidence that an actual precision of classification based on the probability threshold meets a precision condition.
